(19) United States
(12) Patent Application Publication
(10) Pub. No.: US 2019/0090508 A1
(43) Pub. Date: Mar. 28, 2019

(54) Method for Making Horsefeed

(71) Applicant: Deutsches Institut fuer Lebensmitteltechnik e.V., Quakenbrueck (DE)

(72) Inventors: Ansgar Peiss, Bippen (DE); Martina Kiessling, Quakenbrueck (DE)

(21) Appl. No.: 15/864,491

(22) Filed: Jan. 8, 2018

(30) Foreign Application Priority Data
Jan. 6, 2017 (DE) 102017200138
Jan. 9, 2017 (DE) 102017200224.7

(51) Int. Cl. A23K 50/20; A23K 10/30; A23K 20/174

(52) U.S. Cl. CPC A23K 50/20; A23K 40/00; A23K 20/174; A23K 10/30

(57) ABSTRACT

The present invention relates to a process for producing horse feed in which the grains contained are essentially completely swollen, wherein the horse feed in an airtight package is characterized by a shelf-life of at least 6 weeks, preferably of at least 3-6 months, at 20° C. The process results in the horse feed not containing vegetative bacteria or fungi and no mites. The horse feed contains slime formers, e.g. wheat bran and/or linseed, which preferably is ground, the slime of which is developed, respectively available and effective.

The present invention relates to a process for producing horse feed in which the grain contained therein is essentially completely swollen, wherein the horse feed in an airtight package is characterized by a storage life of at least 6 weeks, preferably of at least 3 to 6 months at 20° C. The process results in the horse feed not to contain any vegetative microorganisms, especially no vegetative bacteria or fungi, respectively yeast, and no mites. The horse feed contains slime formers, e.g. wheat bran and/or linseed, which preferably is ground, the slime of which is developed, respectively available and effective. Therefore, the horse feed produced using the process is ready to use, respectively ready for consumption and can be fed directly out of the package. Due to the production process the horse feed preferably has a good digestability, which especially preferably is caused by digestion of the grain contained and/or by a high efficacy of the slime compounds which are contained in the raw materials, especially in the slime formers. The process is characterized in that no increased temperature acts on the raw materials of the horse feed, so that the horse feed is characterized by a high content of easily digestible contents, especially of vitamins. Generally, the horse feed produced by the process can be designated as a durable, ready-to-use, respectively ready for ingestion, moist mash-feed.

### STATE OF THE ART

DE 10 2008 006 363 A1 describes horse feed containing horse muesli, preferably with linseed, in mixture with topinambur, the polysaccharides of which, especially inuline, shall act prebiotically. The horse muesli may contain grains digested by crushing, grinding or toasting.

A horse feed that is ready for direct use, the grain contents of which are essentially swollen and moist and which is durable, is not available. This is believed to be due to the fact that to-date no process is utilized for preserving horse feed having swollen grains which process maintains vitamins and results in a shelf-life of at least 6 weeks at 20° C.

### OBJECT OF THE INVENTION

The invention has the object to provide an alternative production process for ready-to-use horse feed and to provide the ready-to-use horse feed, containing swollen grain and which is durable for at least 6 weeks at 20° C.

### BRIEF DESCRIPTION OF THE DRAWING

FIG. 1 is a data plot showing measuring values of the rheologic properties of horse feed produced according to the invention and as a reference of an identical mixture, which was not treated with the high pressure.

### DESCRIPTION OF THE INVENTION

The invention achieves the object with the features of the claims and especially by a process for producing horse feed with the steps
1. mixing of grains and at least one slime former, which is selected among grain bran, preferably wheat bran, and/or linseed,
2. optionally adding apple pomace,
3. preferably, optionally brewers grains and/or brewer's yeast, e.g. spent grain or wheat bran with brewer's yeast, wherein the brewer's yeast can be bound to brewers grains or to bran,
4. optionally adding of functional additives, e.g. selected among vitamines and trace elements,
5. optionally adding of fruit, vegetables, e.g. carrots, parsnips, bananas, apples and/or herbs, preferably chopped,
6. preferably adding of preservative agents, preferably selected among potassium sorbate and/or sodium propionate,
7. optionally adding of at least one acidifying agent,
8. adding and mixing in of water, preferably drinking water, e.g. tap water, preferably at a temperature of the least 40° C., preferably of maximally 85° C., for generating an aqueous grain mixture,
9. filling of the aqueous grain mixture into airtight, elastic packages and
10. exercising of static pressure of the least 4,000 bar, preferably up to 6,000 bar, for at least 3 to 5 minutes.

By exercising the static pressure the horse feed produced according to the invention is obtained. The horse feed is characterized in that it is shelf-stable for at least 6 weeks, preferably for at least 3 months, more preferably for at least 6 months, at 20° C., and is directly ready-to-use, respectively ready for consumption. Preferably, the horse feed is characterized in that it contains an increased content of effective, respectively available slime compounds in comparison to the aqueous grain mixture, and/or that the cereal grains are at least partially digested so that they are more readily digestible. It is currently assumed that the content of effective slime compounds is based on the effect of the static pressure on the slime formers and it is therefore preferred that the horse feed only contains slime formers which are grains or grain components, especially bran and/or linseed, and it is further preferred that the horse feed does not contain slime-forming polysaccharide which is no grain component or does not originate from linseed, e.g. no added topinambur and no added inuline.

The efficacy, respectively increased availability of the slime compounds can generally be determined with the following steps: Oscillation test of the aqueous phase of the horse feed: A solid phase is separated from the aqueous phase by centrifugation. For the aqueous phase the elastic properties are determined in a voltage-controlled oscillation rheometer (e.g. type AR 2000, TA-instruments, Newcastle, USA, cone-plate-system, cone diameter 4 cm, cone opening angle 4°, measuring temperature 20° C., measuring time 5 min, frequency range: 1 to 10 Hz). Therein, under oscillation the memory module is registered in dependence on the oscillation frequency.

Generally the efficacy, respectively availability of the slime compounds in horse feed can be done by measuring the rheologic properties using a rheometer, e.g. by a rheometer type AR 2000, TA instruments, Newcastle, USA, using the measuring system starch cell, and determining the torque with increasing shear time.

The water is preferably added to a content of 60 to 75 wt.-% of the aqueous grain mixture. The solid ingredients are preferably utilized at 0° C. to room temperature.

Optionally plant oil can be added to the grains, e.g. soy oil, linseed oil, sunflower oil, rape seed oil and/or maize-germ oil, e.g. following one of the steps 1 to 8. Plant oil can e.g. be added to 0.3 to 2 wt.-% of the horse feed.

Prior to adding the water, preferably a pre-mixture can be produced from the solid constituents by mixing, to which pre-mixture subsequently the water is added.

The grains are preferably selected from barley, oats and/or wheat, each preferably squashed to flakes and/or toasted, and mixtures of at least two of these.

The optional acidifying agent, e.g. citric acid, is added in order to adjust the aqueous grain mixture to a pH of at maximum 4, e.g. to 1.5 to 2.5 wt.-% of the aqueous grain mixture in order to adjust the pH value of below 4.

Alternatively or additionally to the addition acidifying agent the aqueous grain mixture can be fermented, e.g. until a pH of 4 is reached, prior to filling into flexible, airtight packages and exerting the hydrostatic pressure The fermentation can be done by the autochtonous microorganisms of the raw materials, especially of the grains and/or of the bran, and/or by adding a starter culture for a lactic acid fermentation and incubating. As a starter culture, lactic acid bacteria can be added as microorganisms, e.g. lactobacilli and/or leuconostoc. The fermentation can be done at 10 to 35° C., preferably at 30° C. by incubation, e.g. until a pH of approximately 4 is reached, e.g. for 0.5 to 2 days. Such a fermentation step has the advantage to lower the phytate content of the grain mixture and to therefore increase the available content of soluble iron, zinc and calcium. The subsequent exertion of the hydrostatic pressure results in inactivation also of the added microorganisms. Preferably the fermentation step results in a lower content of the horse feed that is obtained after exerting the static pressure, of bacterial spores and/or fungal spores. This is traced back to the bacterial spores and/or fungal spores being able to germinate during the fermentation and are therefore inactivated by the subsequent exertion of the static pressure.

Potassium sorbate can e.g. be added to 0.2 wt.-%, sodium propionate e.g. to 0.1 wt.-% in relation to the finished horse feed, respectively in relation to the aqueous grain mixture. The preferred addition of preservative agents, preferably only occurs to a content which is sufficient to suppress the growth of bacterial spores and/or of fungal spores which germinate during storage of the horse feed.

Vitamins are e.g. vitamin A, vitamin D3, vitamin E and/or biotin, preferably all of these. Trace elements are e.g. iron, e.g. as iron(II)-sulphate, copper, e.g. as copper(II)-sulphate, manganium, e.g. as manganium(II)-oxide, zinc, e.g. as zinc oxide, iodine, e.g. as calcium jodate, selenium, e.g. as sodium selenite, and/or cobalt, e.g. as cobalt(II)-carbonate, preferably on a carrier material as granules, preferably all of these.

Optionally, spores of nematicidal fungi, e.g. of Duddingtonia flagrans, can be added to the aqueous grain mixture prior to the filling into airtight and elastic packages, respectively prior to exerting the hydrostatic pressure, preferably following an optional fermentation step, respectively directly prior to the filling into the packages and exerting hydrostatic pressure. The content of the horse feed of spores of nematicidal fungi results in a decrease of the nematode burden in the horse. The advantage of the treatment of the aqueous grain mixture with the hydrostatic pressure is that spores of nematicidal fungi are not or not completely inactivated, due to the low pH of the horse feed do not germinate during the storage and therefore can become active after the ingestion by a horse. Nematicidal fungi preferably are Mucor circinelloides, Duddingtonia flagrans and/or Verticillium chlamydosporium, preferably Mucor circinelloides and Duddingtonia flagrans. The spores can e.g. be added to a concentration of a total of approximately 1×10⁶ to 5×10⁶ spores per kg of aqueous grain mixture.

Further optionally, water can be added to the grains to allow germination, e.g. prior to step 1. For this, the grain is not pre-treated and is incubated with the added water, e.g. at 10 to 20° C. for 1 to 10 days, preferably in a single layer with controlled aeration.

Generally, the horse feed produced according to the invention can be designated as mash-feed, in which the grains are swollen and which has a mushy consistency. Preferably, the horse feed produced according to the invention does not contain unbound water and water not taken up by solid constituents is combined with slime compounds, respectively adsorbed to slime compounds.

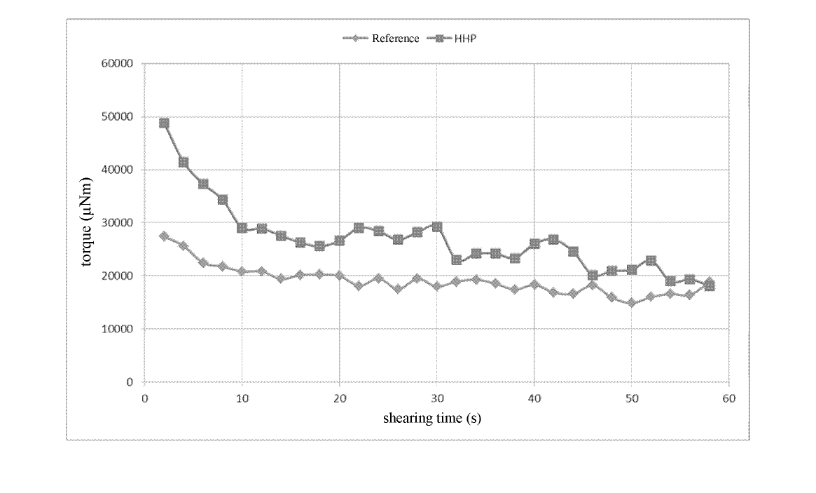

The invention is subsequently described by way of examples with relation to the FIG. 1, showing measuring values of the rheologic properties of horse feed produced according to the invention and as a reference of an identical mixture, which was not treated with the high pressure.

### Example 1: Production of Horse Feed

As grains, toasted barley flakes, crushed oats, wheat bran, forage oats in flakes, ground linseed as slime former with brewer's yeast on wheat bran with a content of soy oil and sodium chloride, spent grain with brewer's yeast and apple pomace, vitamins and trace elements, 1 wt.-% citric acid, 0.2 wt.-% potassium sorbate and 0.1 wt.-% sodium propionate, each in relation to the aqueous total mixture, mixed with 70 wt.-% tap water (85° C.), in relation to the aqueous total mixture, were added and mixed. The vitamines in relation to 1 kg of the above-mentioned dried constituents were 10,300 I.E. vitamin A, 1,143 I.E. vitamin D3, 46 mg vitamin E and 114 mg biotin. The trace elements, granules on a carrier, were 22 mg iron as iron(II)-sulphate, 25 mg copper as copper(II)-sulphate, 57 mg manganium as manganium(II)-oxide, 86 mg zinc as zinc oxide, 1.142 mg iodine as calcium jodat, 0.36 mg selenium as sodium selenite and 0.46 mg cobalt as cobalt(II)-carbonate. The pH of the aqueous grain mixture was approximately 4.

The resulting aqueous grain mixture was filled at 1 kg each in aluminum-coated bags of plastic film as airtight packages and these were welded close completely free of air bubbles. These packages were subjected for 3 min to a hydrostatic pressure of 6,000 bar in a high-pressure chamber (NC-Hyperbaric, Spain). The pressure was built up over 6 to 7 min to 6,000 bar, maintained for the time of 3 min, and subsequently released. As a result, the horse feed produced according to the invention was obtained.

The analysis of the horse feed in comparison to the aqueous grain mixture directly prior to the high-pressure treatment resulted in a higher proportion of slime compounds and therefore in an increased efficacy of the slime compounds contained in the raw materials used.

It was found that the shelf life upon storage of the horse feed at 20° C. was at least 58 days. For comparison the same aqueous grain mixture, but without citric acid, was prepared and treated equally. This non-acidified mixture showed a shelf-life of only 28 days. The shelf-life was determined by analysis of the aerobic mesophilic total germ number.

It was found that the slime compounds following the high-pressure treatment of the aqueous grain mixture in the horse feed produced are available to a higher degree and/or with higher efficacy and can therefore act directly in the throat and stomach of the horse. This effects a digestion gentle for the stomach and for the intestinal wall. The horse feed produced according to the invention is therefore digestible better than the aqueous grain mixture prior to the high-pressure treatment.

### Example 2: Production of Horse Feed Using Fermentation

The aqueous grain mixture of Example 1, but without addition of the citric acid was temperature-controlled to 20° C., a starter culture was added, and it was incubated for 2 to 5 days without agitation, prior to the subsequent filling into the bags of plastic foil, welding these close and treating with high pressure as described in Example 1.

The horse feed produced this way also showed an increased efficacy of the slime compounds in comparison to the aqueous grain mixture prior to the high-pressure treatment, and a shelf-life at 20° C. of at least 58 days.

### Example 3: Production of Horse Feed with Nematicidal Fungal Spores

To the aqueous grain mixture of Example 1, 2×10⁶ spores of each of Duddingtonia flagrans and of Mucor circinelloides were added and directly subsequently filled into bags of plastic foil, welding these close and treating them with high pressure, as described in Example 1. Alternatively, spores of Duddingtonia flagrans and of Mucor circinelloides were added to the fermented grain mixture of Example 2 directly prior to the filling into bags of plastic foil, filled and treated with the high pressure.

Subsequent to the storage at 20° C. for 6 weeks it was found that the spores of Duddingtonia flagrans and of Mucor circinelloides at least to a proportion were viable, preferably following thinning, respectively neutralising the acid.

### Example 4: Producing Horse Feed with Germinated Grains

As grains, germinated barley, toasted barley flakes, crushed oats, wheat bran, forage barley flakes, ground linseed as slime former with brewer's yeast on wheat bran with a content of soy oil and sodium chloride, spent grains with brewer's yeast and apple pomace, vitamins and trace elements, 1 wt.-% citric acid, 0.2 wt.-% potassium sorbate and 0.1 wt.-% sodium propionate, each in relation to the aqueous total mixture, was mixed, and 70 wt.-% tap water (85° C.) in relation to the aqueous total mixture was added and mixed. The germinated barley was obtained by watering of barley and incubating at 20° C. under controlled aeration for 10 days.

The aqueous grain mixture was filled into bags of plastic foil as described in Example 1 and treated with the high pressure. The analysis of the horse feed produced this way shows higher contents of the vitamins, especially of B1, B2, C, E, niacine and folic acid, as well as of trace elements, especially of iron, calcium, zinc and magnesium in relation to the horse feed of Example 1. The shelf-life and the content of slime compounds were reached in accordance with the horse feed of Example 1.

### Example 5: Measuring the Rheologic Properties of Horse Feed Produced According to the Invention

The horse feed was mixed from 26.64 g of a commercially obtainable dry Mash mixture for horses, 4.00 g apple pomace (Herbavital F12, agro Food Solution GmbH), 68.00 g tap water, 68° C., and 1.36 g crystalline citric acid, and this aqueous grain mixture was allowed to swell for 35 min at room temperature, of this one half was treated in a sealed plastic bag with high pressure of 6000 bar for 3 min, and the other half was used as a comparative mixture without high pressure treatment. Subsequently, the horse feed produced by the high-pressure treatment (HHP) and the comparative mixture (Reference) were stored for 2 h at 38° C. For measuring, both samples were used completely. In the rheometer (type AR 2000, TA-instruments), using a so-called starch cell (SPC) as the measuring system (static beaker, therein coaxially with a spacing, the rotor with radial mixing baffels, driven at constant rotation speed, measurement of the torque) the torque during the shearing was registered. FIG. 1 by way of the measuring values shows that the horse feed produced according to the invention contains more long-chain molecules than the reference. The shearing with increasing time results in a denaturation of these long-chain molecules and only then to a decrease of the torque measured. This behavior is presently believed to be due to folding-open the long-chain molecules by the shearing with increasing time.

This measurement shows that the process according to the invention results in an increase of the efficacy, respectively in an increase of the availability of slime compounds.

1. Process for producing horse feed comprising the steps of
1. mixing grain and at least one slime former, which is grain bran and/or linseed,
2. optionally adding apple pomace,
3. optionally adding brewers grains, bran and/or brewer's yeast,
4. optionally adding of fruit, vegetables, e.g. carrots, parsnips, bananas, apples and/or herbs,
5. optionally adding of vitamins and trace elements,
6. optionally adding preservative agents,
7. optionally adding at least one acidifying agent,
8. adding and mixing in of water for generating an aqueous grain mixture,
9. filling of the aqueous grain mixture into airtight elastic packages and
10. exerting static pressure of at least 4000 bar for at least 3 min.

2. Process according to claim 1, characterized in that the added water has a temperature of 0 to 85° C.

3. Process according to claim 1, characterized in that the static pressure is at least 5000 to at least 6000 bar.

4. Process according to claim 1, characterized in that the static pressure is exerted for at least 4 min.

5. Process according to claim 1, characterized in that the grain is barley, oat, wheat or a mixture of these.

6. Process according to claim 1, characterized in that the grain is crushed to flakes and/or is toasted.

7. Process according to claim 1, characterized in that the aqueous grain mixture prior to the filling and the exertion of the static pressure is fermented until reaching a pH value of 4.

8. Process according to claim 1, characterized in that prior to the filling and the exertion of the static pressure a starter culture for a lactic acid fermentation is added to the aqueous grain mixture and this is incubated.

9. Process according to claim 1, characterized in that directly prior to the filling and the exertion of the static pressure spores of at least one nematicidal fungus are added to the aqueous grain mixture.

10. Process according to claim 1, characterized in that prior to the mixing at least a proportion of the grain is allowed to germinate.

11. Process according to claim 1, characterized in that it contains only slime formers which are grains or grain constituents.

12. Process according to claim 1, characterized in that a pre-mixture is produced of the grain and at least one slime former which has grain bran and/or linseed, optionally apple pomace, optionally brewers grains, brans and/or brewer's yeast, optionally vitamins and trace elements, optionally plant oil, optionally at least one acidifying agent, optionally preservative agents, to which pre-mixture subsequently water is added and mixed in for generating an aqueous grain mixture.

13. Process according to claim 1, characterized in that water is added in an amount and mixed in such that in the aqueous grain mixture in the horse feed obtained prior to and/or after exerting the static pressure the water is contained only in the solid constituents and bound to slime compounds.

14. Horse feed that comprises swollen grains, is contained in an air tight elastic package and is shelf-stable for at least 6 weeks at 20° C., obtainable according to a process according to claim 1.

15. Horse feed according to claim 14, characterized in that it does not contain vegetative fungi and no vegetative bacteria.

16. Horse feed according to claim 14, characterized in that it contains spores of at least one nematicidal fungus.
